(19) United States
(12) Patent Application Publication
(10) Pub. No.: US 2014/0191009 A1
(43) Pub. Date: Jul. 10, 2014

(54) PROPELLANT CONTAINER FOR COMBUSTION-OPERATED BOLT-FIRING TOOLS

(71) Applicant: Stefan Mayer, Munich (DE)

(72) Inventor: Stefan Mayer, Munich (DE)

(73) Assignee: Hilti Aktiengesellschaft, Schaan (LI)

(21) Appl. No.: 14/122,706

(22) PCT Filed: Apr. 24, 2012
(86) PCT No.: PCT/EP2012/057461

§ 371 Date: Jan. 20, 2014

(30) Foreign Application Priority Data
Jun. 20, 2011 (DE) 10 2011 077 832.2

(51) Int. Cl. B25C 1/08; F17C 13/02

(52) U.S. Cl. CPC B25C 1/08; F17C 13/02
USPC 227/2; 206/6; 220/560.04; 227/9; 173/1

(57) ABSTRACT

The invention relates to a propellant container for combustion-operated bolt-firing tools (1), having a housing and a housing interior for holding propellant. In order to further simplify the operation of a bolt-firing tool, a sensor device is arranged in the housing interior, said sensor device sensing at least one state variable in the housing interior.

### TECHNICAL FIELD

The invention concerns a propellant container for combustion-operated bolt-firing tools, with a housing and a housing interior for holding propellant. The invention further concerns a bolt-firing tool with such a propellant container. In addition, the invention concerns a process to operate such a bolt-firing tool.

### STATE OF THE ART

A propellant container for combustion-operated bolt-firing tools with a housing and a housing interior for holding propellant is known from German Patent Specification DE 103 19 646 B3. An identification data storage unit is mounted on the propellant container, in which propellant fill level data can be stored and read.

### REPRESENTATION OF THE INVENTION

The problem of the invention is to further simplify the operation of the bolt-firing tool in accordance with the preamble of Claim 1.

For a propellant container for combustion-operated bolt-firing tools, with a housing and a housing interior for holding propellant, the problem is solved with the arrangement of a sensor device in the housing interior that measures at least one state variable in the housing interior. The bolt-firing tools are preferably configured as portable handheld units. For setting a fastener, gas is the preferred propellant. In a combustion chamber of the bolt-firing tool, the propellant from the propellant container is mixed with oxygen or air to form an ignitable mixture. When the ignitable mixture is ignited, it explodes and drives a working piston. Through the sensor device according to the invention, in the housing interior of the propellant container, a precise measurement of the state of the propellant in a simple manner is possible. The sensor device can be integrated into the propellant container when the propellant is filled or during manufacture of the propellant container. Using the sensor device, desired state variables can be measured directly in the propellant.

A preferred design example of the propellant container is characterized in that an electronic system is arranged in the housing interior that includes the sensor device and/or a signal generator device. With the electronic system in the housing interior, the sensor values or signals delivered by the sensor device or the signal generator device in the housing interior can be processed or transmitted to a processing unit in the bolt-firing tool.

A further preferred design example of the propellant container is characterized in that the sensor device and/or a signal generator device in the housing interior is/are connected to an electronic system that is mounted on the outside of the propellant container. The sensor values or signals measured in the housing interior can be transmitted wirelessly, for example via a radio link, to the electronic system mounted on the outside of the propellant container.

Another preferred design example of the propellant container is characterized in that the sensor device or the electronic system is configured in such a way that at least one, several or each of the following state variables of the propellant in the housing interior is/are measured: propellant temperature, propellant pressure, propellant fill level, mix ratio. The state variables can favorably be used in the bolt-firing tool to control or regulate the sequence of functions in the operation of the bolt-firing tool.

A further preferred design example of the propellant container is characterized in that the electronic system comprises a microcontroller with or without a storage unit. The storage unit allows the sensor values measured by the sensor device to be permanently or only temporarily stored.

Another preferred design example of the propellant container is characterized in that the electronic system exhibits a communication interface. The communication interface allows, for example, the transmission of sensor values measured by the sensor device and/or signals generated by the signal generator, wirelessly, for example via radio, or via a contact-based connection, to the device electronics of the bolt-firing tool arranged outside the propellant container.

A further preferred design example of the propellant container is characterized in that the electronic system includes an antenna. The antenna can protrude from the propellant container or can be integrated into the housing of the propellant container.

Another preferred design example of the propellant container is characterized in that the sensor device comprises multiple sensors, and/or in that the signal generator device comprises multiple signal generators. The sensors and/or the signal generators can be integrated into the electronic system. The sensors or the signal generators can, however, also be arranged on the outside of the electronic system, and only be connected to it wirelessly or via corresponding signal lines.

A further preferred design example of the propellant container is characterized in that the housing is configured as a can containing liquefied gas. Such a propellant container is also referred to as a gas can or gas cartridge. The gas can or gas cartridge is preferentially designed to be a reusable can or a reusable cartridge.

The above-mentioned problem is alternatively or additionally solved by a bolt-firing tool with a previously described propellant container that is connectable or connected to a combustion chamber, and with electronic control, that is electronically, in terms of control and/or in terms of control engineering, connectable or connected to the sensor device in the housing interior. The connection between the sensor device in the housing interior and the electronic control of the bolt-firing tool preferably takes place via the electronic system, which can be inside the housing interior or mounted on the outside of the propellant container.

For a process to operate a previously described bolt-firing tool, the above-mentioned problem is alternatively or additionally solved in that at least one state variable is measured in the housing interior. The measured state variable is preferentially used in the bolt-firing tool to control and/or regulate at least one function of the bolt-firing tool. In doing so, the measured state variable can be used for diagnostic purposes, to set a dosing quantity, to set an ignition point and/or to display a fill level of the propellant container.

Additional benefits, characteristics and details of the invention arise from the following description, in which different design examples are described in detail with reference to the drawing:

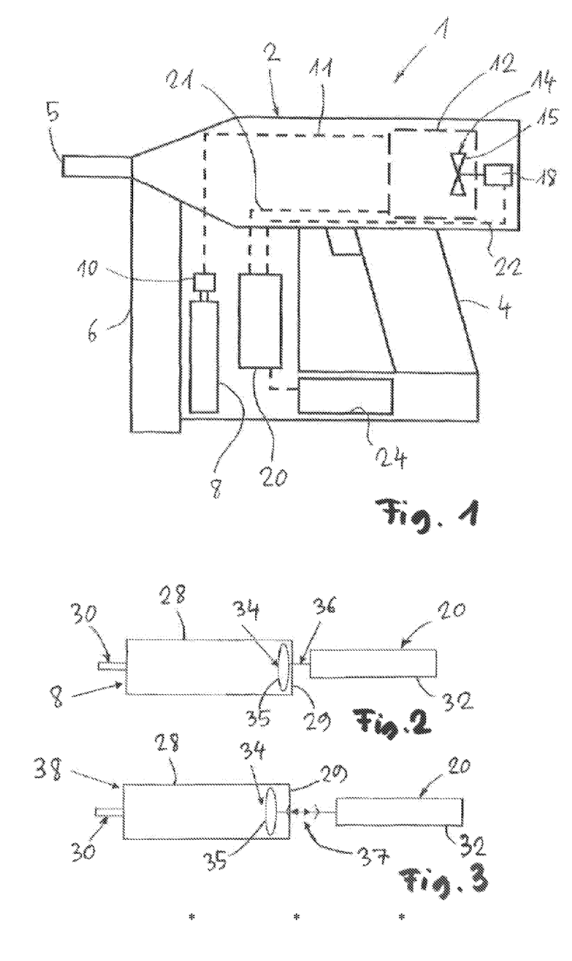

FIG. 1 shows a simplified depiction of a bolt-firing tool;

FIG. 2 shows a simplified depiction of a propellant container that is connected to the device electronics of the bolt-firing tool from FIG. 1 via a communication cable;

FIG. 3 shows a depiction similar to FIG. 2, in which the device electronics are connected to the propellant container via a radio link.

### DESIGN EXAMPLES

A bolt-firing tool 1 with a housing 2 is depicted in FIG. 1 in an extremely simplified manner. The housing 2 comprises a handle 4 with which the bolt-firing tool 1 can be seized to drive a fastener, which exits from the bolt-firing tool 1 on a bolt-firing end 5 and can be driven into a base.

The used fasteners are preferably made available via a magazine 6 inside the device, mounted near the bolt-firing end 5 of the bolt-firing tool 1. The fasteners are preferentially automatically taken individually from the magazine 6 and made available on the bolt-firing end 5.

The power necessary to drive the fasteners into the base is provided in a propellant container 8 configured as a gas can or a gas cartridge in the interior of the bolt-firing tool 1. The propellant container 8 is connectable to a combustion chamber or a combustion space 12 via an adjustable or controllable metering valve 10 and a gas line 11.

In the combustion space 12, gas from the propellant container 8 is mixed with air to form an ignitable mixture that is ignited to drive a fastener, such as a bolt or a nail, into the base. The power necessary to drive the fastener into the base is, for example, transmitted from the ignition space 12 to a fastener on the bolt-firing end 5 via a (not depicted) working piston.

A device 14, which serves to create turbulence in the combustion space 12 and to flush and/or cool the combustion space 12, is placed in the combustion space 12. The device 14 comprises a ventilator 15 powered by an electromotor 18. The electromotor 18 is actuated via an electronic control unit 20.

An ignition cable 21 extends from the electronic control unit 20 to the combustion space 12. The ignitable mixture in the combustion space 12 is ignited via the ignition cable 21.

The electromotor 18 is also connected to the electronic control unit 20 via a motor control line 22. In addition, an electric energy storage device 24, from which the electromotor 18 derives its drive power, is connected to the control unit 20.

In FIGS. 2 and 3, the propellant container 8; 38 and the control unit are depicted alone in accordance with two different design examples of the invention. The propellant container 8; 38 is configured as a gas can with a housing 28, which essentially has the form of a straight circular cylinder jacket. The housing 28 is closed on one end with a base 29. On the other end, the housing 28 exhibits a connector device 30 that, preferentially in combination with a corresponding valve device, allows a defined discharge of propellant from the propellant container 8; 38 via the gas line 11 into the combustion space 12 of the bolt-firing tool 1.

The control unit 20 of the bolt-firing tool 1 comprises device electronics 32 that are connected to an electronic system 34 in a housing interior space of the housing 28 of the propellant container 8; 38. The electronic system 34 in the interior of the housing 28 includes a sensor device 35 that allows the measurement of the state variables of the propellant in the housing 28.

The electronic system 34 preferentially comprises multiple sensors or signal generators that particularly measure the temperature, the pressure and/or the mix ratio of the propellant in the housing 28. The electronic system 34 also comprises a microcontroller, preferably with a storage unit. The sensor data are received, processed and/or stored by the microcontroller. In addition, the electronic system 34 includes a communication interface that allows the exchange of data with the device electronics 32.

The line 36 in FIG. 2 indicates that the device electronics 32 are connected to the electronic system 34 in the housing 28 of the propellant container 8 via a connecting cable or communication cable. It is also possible for only the sensor device 35 to be placed in the interior of the housing 28.

The electronic system 34 can also be mounted on the outside of the housing 28. In that case it is advantageous if the sensor device 35 is wirelessly connected to the electronic system 34. The electronic system 34 mounted on the outside can be connected to the device electronics 32 of the bolt-firing tool 1 via the communication cable or connecting cable.

The double arrow symbol 37 in the design example shown in FIG. 3 indicates that the electronic system 34 with the sensor device 35 in the interior of the housing 28 is wirelessly connectable or connected to the device electronics 32 of the bolt-firing tool 1 via a radio link. The advantage of a wireless connection is that there is no need for a clearance hole to pass the connecting cable or communication cable through the housing 28.

1. A propellant container for combustion-operated bolt-firing tools, comprising a housing, a housing interior for holding propellant, and a sensor device, wherein the sensor device is arranged in the housing interior and senses at least one state variable in the housing interior.

2. The propellant container according to claim 1, further comprising an electronic system arranged in the housing interior, the electronic system including the sensor device and/or a signal generator device.

3. The propellant container according to claim 1, wherein the sensor device in the housing interior is connected to an electronic system that is mounted on an outside of the propellant container.

4. The propellant container according to claim 2, wherein the sensor device is configured in such a way that at least one, several or each of the following state variables of the propellant in the housing interior is/are measured: propellant temperature, propellant pressure, propellant fill level, and mix ratio.

5. The propellant container according to claim 2, wherein the electronic system comprises a microcontroller with or without a storage unit.

6. The propellant container according to claim 2, wherein the electronic system exhibits a communication interface.

7. The propellant container according to claim 2, wherein the electronic system includes an antenna.

8. The propellant container according to claim 2, wherein the sensor device comprises multiple sensors, and/or the signal generator device comprises multiple signal generators.

9. The propellant container according to claim 1, wherein housing is configured as a can containing liquefied gas.

10. A bolt-firing tool with a propellant container according to claim 1, which is connectable or connected to a combustion chamber, and with an electronic control, that is electronically connectable or connected to the sensor device in the housing interior.

11. A process for the operation of a bolt-firing tool according to claim 10, comprising measuring at least one state variable the housing interior.

12. The process according to claim 11, comprising using the measured state variable to control and/or regulate at least one function of the bolt-firing tool.

13. The process according to claim 11, comprising using the measured state variable for diagnostic purposes, to set a dosing quantity, to set an ignition point and/or to display a fill level of the propellant container.

14. The propellant container according to claim 3, wherein the sensor device is configured in such a way that at least one, several or each of the following state variables of the propellant in the housing interior is/are measured: propellant temperature, propellant pressure, propellant fill level, mix ratio.

15. The propellant container according to claim 3, wherein the electronic system comprises a microcontroller with or without a storage unit.

16. The propellant container according to claim 4, wherein the electronic system comprises a microcontroller with or without a storage unit.

17. The propellant container according to claim 3, wherein the electronic system exhibits a communication interface.

18. The propellant container according to claim 4, wherein the electronic system exhibits a communication interface.

19. The propellant container according to claim 5, wherein the electronic system exhibits a communication interface.

20. The propellant container according to claim 3, wherein the electronic system includes an antenna.
